(19) United States
(12) Patent Application Publication
(10) Pub. No.: US 2009/0061230 A1
(43) Pub. Date: Mar. 5, 2009

(54) Synthesis of Titanium Dioxide Nanoparticles

(75) Inventors: Michael Berkei, Haltern am See (DE); Helga Bettentrup, Steinfurt (DE)

Correspondence Address: HARNESS, DICKEY & PIERCE, P.L.C., P.O. BOX 828, BLOOMFIELD HILLS, MI, 48303, US

(73) Assignee: NANOGATE AG, Saarbrucken (DE)

(21) Appl. No.: 11/718,133

(22) PCT Filed: Nov. 2, 2004
(86) PCT No.: PCT/EP04/12376

§ 371 Date: May 22, 2008

(51) Int. Cl. B32B 15/02; C07F 7/28

(52) U.S. Cl. 428/402.24; 556/54; 977/773

(57) ABSTRACT

The present invention relates to a process for the production of titanium-containing oxide particles having an average primary particle size of 25 nm or less, which comprises the reaction of a hydrolysable halide-containing titanium compound with water in a reaction mixture comprising a polyol, and the particles obtainable thereby. The claimed method is suitable for an industrial upscale and allows the formation of concentrated stable and transparent dispersions in water without the aid of dispersing agents such as surfactants.

### FIELD OF THE INVENTION

The present invention relates to the synthesis of titanium dioxide (TiO₂) nanoparticles and titanium dioxide nanoparticles obtainable by this synthesis.

### BACKGROUND OF THE PRESENT INVENTION

Nanoparticulate titanium dioxide is well known, but still attracts considerable interest in view of its numerous commercial applications. Fine titanium dioxide particles can for instance be used as a metal oxide semiconductor, as described in U.S. Pat. No. 5,084,365 (M. Grätzel). The so-called Grätzel-cell disclosed in this patent is capable of converting light energy into electric energy (solar cell). Titanium dioxide nanoparticles are also employed for increasing the refractive index of fluids or polymers in those cases where transparency is of essence. Similarly, titanium dioxide nanoparticles can be advantageously incorporated in coating compositions (see for instance EP 0 634 462 A2). In catalytic processes they may serve as substrate for the actual catalytically active species (DE 19 913 839 AI). Due to their very high surface area, they are also particularly suited for photocatalytic processes (see also CN 1 337 425). Furthermore, they are included in incombustible materials (see for instance EP 1 072 670 A2). In the area of textile materials, titanium dioxide nanoparticles catalytically enhance the decomposition of soil particles. The versatile applications of this material also account for the fact that numerous patent applications and patents deal with its synthesis.

U.S. Pat. No. 3,488,149 discloses a process for the preparation of finely divided titanium dioxide by converting a volatile titanium compound, preferably titanium chloride in the presence of a boron material. The use of a vapor phase oxidation reaction using a plasma stream of at least 3000° C. is preferred. However, vapor phase nanoscale titanium dioxide tends to agglomerate and is not readily dispersible in water and organic solvents.

G. Oskam et al, J. Phys. Chem. B. 2003, 107, 1734-1738, “The growth Kinetics of TiO₂ nanoparticles from titanium (IV) alkoxide at high water/titanium ratio” describes TiO₂ nanoparticles synthesized from aqueous solution using titanium (IV) isopropoxide as precursor. The radius of primary particles was found to be between 1, 5 and 8 nm.

CN 1 381 531 pertains to a process for preparing spherical rutile-type nanometer TiO₂ from TiCl4 under the action of polyester-modified high molecular organosilicon polymer. The use of such dispersing additives is however undesired since it opposes applications where high purity TiO₂ is required.

CN 1 373 089 discloses a process for preparing anatase-phase nano-TiO₂ which includes the steps of dissolving metatitanic acid in sulphuric acid to obtain titanyl sulphate, adding dropwise an alkaline solution thereto to obtain titanic acid, washing, drying and calcining.

The subject matter of CN 1 363 520 is a process for preparing nano rutile-type TiO₂ from titanium sulphate including the steps of preparing hydrolytic crystal seeds with ammonium tetraminozincate, hydrolyzing, washing in water to obtain meta-titanic acid, washing to obtain n-titanic acid, preparing a sol of TiC-2, coagulating the obtained gel, calcining and pulverizing.

According to the teaching of CN 1 343 745, a rutile-type nanometer TiO₂ is prepared from tetravalent titanium with a specific Fe/TiO₂ ratio through hydrolysis by adding diluted alkali solution and crystal seeds to the tetravalent titanium.

CN 1 340 459 describes a process for preparing superfine TiO₂ particles from the waste material generated in the production of titanium dioxide powder with the sulphuric acid method including various cleaning and dissolution steps to obtain a pure Ti solution. After hydrolysis, filtering and drying steps, precursor titania monohydrate is calcined to obtain superfine anatase-type TiO₂ particles.

CN 1 316 383 concerns the preparation of nanometer rutile-type TiO₂ from titanium dioxide sulphate as main raw material.

CN 1 312 223 describes a production method for nanometer TiO₂ including the following steps, selecting a metal salt capable of dissolving in water or an organic solvent, uniformly mixing and selecting a proper precipitant or adopting the processes of evaporation, crystallization, sublimation and hydrolysis to uniformly precipitate and crystallize said metal ions, then dehydrating or decomposing so as to obtain titanium dioxide powder.

CN 1 294 090 discloses a process for preparing nanometer rutile-type TiO₂ including the steps of mixing a solution containing Ti(IV) with alkali solution, reacting to obtain titanium hydroxide precipitate, adding a gelatinizing agent to convert anatase-type crystals to rutile-type crystals drying pulverization.

The subject matter of CN 1 296 917 is a process for preparing nanometer spherical TiO₂ particles including the dispersion of SiO₂ particles in a polar organic solvent followed by adding water and/or ammonia water and then titanate. The reaction is conducted at 25 to 45° C. over 3 to 48 hours.

CN 1 363 521 proposes a process for preparing nano anatase-type TiO₂ from metatitanic acid, said process comprising the steps of dissolving a suitable precursor in alkali solution to obtain n-titanic acid, dissolving in an acid solution to obtain a TiO₂ sol, coagulating, dewatering, extracting with an organic substance, separating the TiO₂ sol and calcining. The resulting particle size is said to be 5 to 30 nm.

U.S. Pat. No. 6,001,326 (Kim et al) discloses a method for production of mono-dispersed and crystalline titanium dioxide ultrafine powders comprising the steps of preparing an aqueous titanyl chloride solution under ice-cooling, diluting the same and heating the diluted aqueous titanyl chloride solution to a temperature of 15 to 155° C. to precipitate titanium dioxide. According to the examples, the primary particle size is about 10 nm.

The process of U.S. Pat. No. 6,517,804 B1 (Kim et al) enables the preparation of downy hair-shaped titanium dioxide powder having a very high specific surface area. The process is similar to that described in U.S. Pat. No. 6,001,326 insofar as titanylchloride solution is used as starting material which is prepared by adding ice pieces or icy distilled water to pure titanium tetrachloride. Example 1 describes the preparation of titanium dioxide powder having a primary particle size of about 10 nm.

Nanoparticulate titanium dioxide particles produced in an aqueous medium, including the aforementioned ones obtained in sol-gel processes suffer however from an insufficient dispersibility in water and organic solvents.

For this reason, often subsequent treatment steps have to be adopted in order to prepare stable dispersions. Such treatments typically involve the use of stability-enhancing additives (dispersants), e.g. citric acid as taught by US 2003/0089278A1 or polymeric dispersants as described for instance in WO 03/084871 A2.

Apart from the above preparation processes based on the hydrolysis of titanium salts/compounds in an aqueous medium, there exist also electrochemical processes for the manufacture of nanoscale titanium dioxide, e.g. WO 02/061183 A2 and DE 10 245 509 B3. The latter document teaches the conversion of metal electrodes to the corresponding oxide nanoparticles under use of a specific voltage- or current-time program.

The manufacture of nano-sized spherical anatase TiO₂ powder under supercritical conditions is known from the Korean patent 00 262 555 B1.

Electrochemical or supercritical conditions require however complicated and expensive equipment and may not be suitable for an industrial upscale.

More promising in this respect is the polyol-mediated preparation of nanoscale oxide or pigment oxide particles as described by Claus Feldmann. Claus Feldmann and Hans-Otto Jungk report in “Polyol-vermittelte Präparation nanoskaliger Oxidpartikel; Angewandte Chemie 2001, 113, No. 2, pages 372-374” the preparation of various multivalent metal oxides from hydrolysable precursors in the presence of diethylene glycol and a small amount of water. The resulting particles have an average particle diameter of about 30 to 200 nm. The metal oxide nanoparticles form diethylene glycol dispersions comprising individual non-agglomerated oxide particles without the presence of additional stabilizers which is emphasized as particular advantage in this reference. Moreover, Feldmann describes that the colloidal state collapses as soon as water is added to the diethylene glycol dispersion which indicates that the particles are not dispersible in water. The experimental section of this reference also includes the-manufacture of titanium dioxide nanoparticles by adding titanium tetrapropoxide to 50 ml diethylene glycol followed by heating to 140° C., adding 2 ml water and heating further over two hours to 180° C. Claus Feldmann, “Preparation of nanoscale pigment particles” in Advanced Materials 2001, 13, No. 17, September 3, pages 1301 to 1303 describes the diethylene glycol-mediated synthesis of various pigments including the titanium-containing pigment (Ti_{0.85} Ni_{0.05}, Nb_{0.10})O₂. Again, titanium tetrapropoxide is used as starting material for the reaction in diethylene glycol to which water is added after heating to 140° C. Then, the temperature is increased to 180° C. According to this reference, the average particle diameter is between 50 and 100 nm.

In view of the above, it is one technical object of the present invention to provide titanium-containing oxide nanoparticles that are not only dispersible-in polyols, but also in water without the aid of dispersants.

It is a further technical object of the present invention to provide titanium-containing oxide nanoparticles furnishing very stable aqueous dispersions.

It is a further, technical object of the present invention to provide nanoparticles of the above-described type that are sufficiently small to enhance the transparency of the resulting dispersions.

Finally, it is an object of the present invention to provide a process leading to titanium-containing oxide nanoparticles meeting with the above requirements.

Further objects become apparent from the following detailed description of the invention.

### SUMMARY OF THE PRESENT INVENTION

The above-described technical objects are achieved by a process for the production of titanium-containing oxide particles, in particular titanium dioxide having an average primary particle size of 25 nm or less, said process comprising the reaction of a hydrolysable halide-containing titanium compound with water in a reaction mixture comprising a polyol; and titanium-containing oxide particles, in particular titanium dioxide having an average primary particle size of 25 nm or less and being surface-modified with at least one polyol.

### DESCRIPTION OF FIGURES

FIG. 1 shows the particle size distribution of nanoparticles according to the present invention, as determined by analytical ultracentrifugation;

FIG. 2 shows the transmission electron microscopy pictures of TiO₂ nanoparticles according to the present invention in two different magnifications; and

FIG. 3 shows the X-ray diffraction of a powder of nanoparticles in accordance with the present invention in comparison to the bulk data for anatase (lower signals).

### DETAILED DESCRIPTION OF THE INVENTION

The titanium-containing oxide nanoparticles of the present invention are preferably crystalline materials, either of rutile or anatase type. For smaller particle sizes, the anatase type seems to be more stable.

The term “primary particle size” refers to the size of the not agglomerated particles which may adopt any shape, for instance spherical, ellipsoid or needle-shaped, approximately spherical particles being preferred. As regards spherical particles, the term “size” corresponds to their diameter, otherwise to the longest axis of the particle. The preferred size ranges from 1 to 20 nm, more preferably from 2 to 15 nm, even more preferably from 3 to less than 10 nm. The size may for example be determined by transmission electron microscopy (TEM). For determining the average size and the standard deviation, the analytical ultracentrifugation, which is known in this technical field, is also particularly suited. Prior to the analytical ultracentrifugation, it may be checked by means of TEM or XRD (X-ray diffraction) measurements whether the particles are present in the non-agglomerated state in order to prevent a falsification of the results.

The method according to the invention leads to a very narrow particle size distribution which can be described by a preferred standard deviation from the average particle size of less than 40%, in particular less than 30%.

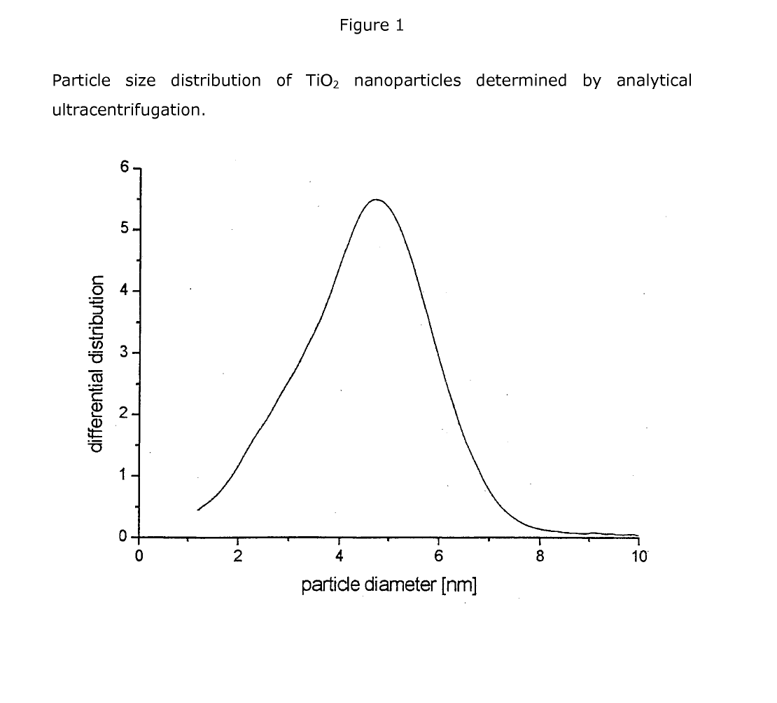

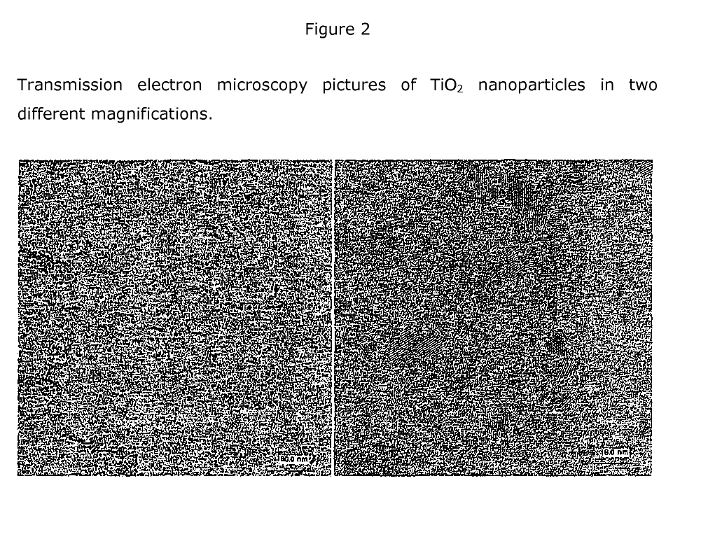

This is confirmed by the analytical ultracentrifugation and transmission electron microscopy data shown as FIGS. 1 and 2.

The term “titanium-containing oxide” comprises all those oxides containing titanium as a metal component and optionally other metals. Examples thereof are the pigment (Ti_{0.85}Ni_{0.05}Nb_{0.10})O₂ or titanium dioxide (TiO₂), the latter being preferred.

The process according to the invention employs a hydrolysable halide-containing titanium compound which is to be understood as inorganic or organic tetravalent titanium compound wherein at least one halide (F, Cl, Br, J) binds to the central titanium atom. The remaining valencies may also be halide atoms or can be represented by typical hydrolysable groups, such as short chain carboxylates (preferably C₁-C₄, for instance acetate), short chain alkoxides (preferably C₁-C₄), such as ethoxide, i-propoxide or t-butoxide, or acetylacetonate (CH₃COCHCOCH₃). Other examples for hydrolysable groups involve Si—O-based groups wherein the oxygen of the Si—O units is linked to the titanium atom, pyrophosphates with aromatic or aliphatic substituents (e.g. alkyl, such as C₄ to C₁₂ alkyl), for instance dioctylpyrophosphato (C₁₆H₃₄O₄P) or sulfonates with long-chain aliphatic or aliphatic-aromatic groups (having preferably 14 to 22 C atoms in total) such as dodecylbenzenesulfonato (C₁₈H₂₇O₃S). It is particularly preferred to use titanium tetrachloride as hydrolysable starting material. Furthermore, it is possible to use mixtures of titanium tetrahalide, in particular titanium tetrachloride with other hydrolysable titanium compounds having organic substituents of the above-described type. Then, the titanium tetrahalide preferably constitutes at least 50 wt.-% of the mixture.

As polyol, organic compounds having two, three or more hydroxy groups and being fully miscible with water can be used. The polyol preferably comprises only C, H and O as elements. The number of C atoms is preferably at least 3. Furthermore, it is preferred that, apart from the hydroxy groups, no further functional groups are attached to the molecule-forming chain. Examples for such polyols are organic di- or trihydroxy compounds having a molecular weight of preferably not more than 200, e.g. glycerol, or polyethylene glycol (the preferred average number of ethylene glycol units being up to 4). According to preferred embodiments, the polyol solvent is selected from polyols having at least one ether linkage and a molecular weight of preferably not more than 200, such as the above-described polyethylene glycols. The use of diethylene glycol is most preferred.

The ratio water/polyol can cover a wide range of preferably 0.01/99.99 to 99/1. Volume ratios water/polyol of 0.01/99.99 to 80/20, 0.01/99.99 to 60/40, 0.01/99.9 to 40/60, 0.01/99.9 to 20/80, 0.01/99.9 to 10/90, 0.01/99.99 to 5/95, 0.01/99.9 to 1/99 and 0.01/99.99 to 0.1/99.9 are more preferred with generally increasing preference in this order. The absence of polyol from the reaction system leads to particles showing an insufficient dispersibility. Experiments with various amounts of water appear to indicate that higher amounts of water complicate the isolation of the formed titanium-containing oxide nanoparticles. Higher amounts of water seem to prevent an easy precipitation and may bring about the need to separate the particles from the reaction system by means of ultrafiltration. The use of very small water amounts in the reaction mixture thus allows the precipitation of the nanoparticles by adding miscible organic solvents to the reaction system that however have a much lower complexing capacity than the polyol. One example for such a precipitating organic solvent is acetone.

Apart from the necessary solubility or dispersibility of the hydrolysable titanium compound in the reaction mixture, there are no specific restrictions regarding its concentration in the reaction mixture. Preferably, it is used in concentrations of 0.01 to 1 mol/1 reaction medium, in particular 0.1 to 0.5 mol/1. Preferably, the molar ratio water/Ti ranges from 40 to 2, which is the stoichiometrically needed amount. More preferably, this ratio is 30 to 2.5, e.g. 20 to 3, 10 to 3 or 5 to 3.

The process according to the invention is preferably performed with heating, i.e. above room temperature (25° C.), preferably above 100° C. To prevent too long reaction times, (maximum) temperatures of typically 140 to 200° C., more preferably 150 to 175° C., are employed.

Even if it is in principle possible to carry out the process according to the invention under increased or reduced pressure, it is for practical considerations preferred to work under normal pressure (1 bar).

For the above-indicated preferred (maximum) synthesis temperatures, usually a reaction time of at least 30 min is selected. Typically, little changes in terms of size and/or crystallinity are observed after about four hours so that longer reaction times may not be economically useful, although it is not harmful to conduct the reaction for more than 4 hours or even one day. The most preferred reaction times are thus 3½ to 4½ hours.

The process of the present invention does not require the addition of any acid or basic compounds for adjusting the pH. Nonetheless, the addition of basic substances may serve the purpose of capturing protons generated by the hydrolysis of the titanium chloride bond. When working in an industrial scale, it may further be of interest to capture the formed acid (e.g. HCL) with nitrogen bases capable of forming ionic liquids such as 1-methylimidazol, in a similar technique as already employed by BASF in their BASIL™ process. Volatile acids such as HCL formed during the reaction can also be expelled by bubbling inert gas such as N2 through the reaction mixture.

Similarly, it is a decisive advantage of this process that dispersing additives of any type can be renounced. Although, it is in principle possible to add miscible organic solvents to the polyol, this is not necessary. Correspondingly, the reaction mixture preferably consists solely of polyol, water and hydrolysable titanium compound.

The present invention also relates to titanium-containing oxide particles, in particular titanium dioxide particles having an average primary particle size of 25 nm or less and being surface-modified with at least polyol. These particles preferably have the characteristics described above and are obtainable according to the claimed process.

The present invention represents a further development of the aforementioned polyol-mediated preparation of oxide particles described by Feldmann (et al). Surprisingly, it has been found that the use of halide-containing titanium compounds, such as titanium tetrachloride instead of titanium tetrapropoxide leads to titanium-containing oxide particles which do not only have a smaller size than described by Feldmann (between 30 to 200 nm), but are also dispersible in water. According to preferred embodiments, the use of smaller molar ratios water/Ti and lower temperatures may further contribute to this favorable finding.

The present invention thus does not only broaden the range of possible applications for titanium dioxide nanoparticles insofar these require the use of aqueous dispersions. One major technological advantage also resides in the smaller size of the particles which reduces the interaction with incident light thereby increasing the transparency of the resulting dispersions.

With the titanium-containing oxide particles of the invention aqueous dispersions having solid contents up to about 70 wt % can be prepared. Their stability increases with lower solid contents and dispersions being stable over several weeks can be achieved with solid contents of up to 30 wt %. This is more than sufficient for the vast majority of industrial applications.

As already described by Feldmann for polyol-based dispersions, it is assumed that the polyol present in the reaction mixture does not only control and terminate nanoparticle growth, but in addition binds to the particle surface with one hydroxy group while the other located at the distal end of the polyol provides the particle with the necessary dispersibility. If it is desired to disperse titanium-containing oxide particles in less polar organic media, for instance in aprotic organic solvents such as chloroform, toluene or xylene, the synthesis product can be subjected to an additional surface modification. For this purpose, the nanoparticles are treated, preferably at an increased temperature of for instance 100 to 240° C., in particular 120 to 200° C. with an organic solvent having a polar functional group binding to the surface of the nanoparticles and a hydrophobic molecular part.

The total number of carbons of this solvent preferably ranges from 4 to 40, more preferably from 6 to 20, in particular from 8 to 16 carbon atoms. The functional group can for instance be selected from hydroxy, carboxylic acid (ester), amine, phosphoric acid (ester), phosphonic acid (ester), phosphinic acid (ester), phosphane, phosphane oxide, sulfuric acid (ester), sulfonic acid (ester), thiol or sulfide. The functional group can also be connected to a plurality of hydrophobic groups. The hydrophobic group is preferably a hydrocarbon residue, e.g. an aliphatic, aromatic or aliphatic-aromatic residue, e.g. alkyl, phenyl or benzyl or methylphenyl. Preferred examples are monoalkyl amines having 6 to 20 carbon atoms, such as dodecyl amine or trialkyl phosphates, such as tributyl phosphate (TBP) or tris(2-ethylhexyl)phosphate (TEHP).

After this surface modification, the particles of the invention are dispersible in common organic solvents at a high concentration. This property can also be utilized for the introduction of the nanoparticles into a polymer medium, for instance by dissolving the polymer in a suitable nanoparticle dispersion, followed by evaporating the solvent.

Furthermore, it is possible to subject the particles to a surface modification involving the reaction of one or more hydroxy groups being not bound to the particle surface with an organic compound having a group capable of reacting with said hydroxy group(s). Thus, it is for instance possible to conduct silylation reactions with reactive silyl compounds, for instance trialkyl monochlorosilyl compounds. Similarly, the free hydroxy group may be subjected to etherification or esterification reactions with suitable starting compounds (e.g. organic acid chlorides or organic compounds with good leaving groups such as OMes or OTos).

The nanoparticles produced can be industrially employed for all those applications where the prior art makes use of the advantageous properties of titanium-containing oxides. Preferred applications involve the incorporation in polymeric materials or coating compositions, the use as catalyst specifically as photocatalyst, the use as semiconductor material, for instance in Gratzel cells, etc.

The present invention will now be illustrated in more detail by the following example.

### EXAMPLE 1

Under vigorous stirring (magnetic stir bar) 600 ml diethylene glycol (Merck; pro synthesis) were charged into a 11-three neck flask having a reflux condenser with vacuum top, temperature probe and stopper, degassed over one hour at 60° C. (heating mantle) and 4 mbar and dried. Depending on the quality of diethylene glycol used, this step can also be renounced. Thereafter, the water content is determined by Karl-Fischer titration (typical values are in the order of 0.03%). Then 20 ml titanium tetrachloride (0.182 mol; Merck; content >99%) and 10 ml distilled water (0.556 mol) are added under nitrogen. The reaction temperature is increased to 160° C. and the reaction mixture is heated 4 hours under reflux.

Two 200 ml volumina of the reaction mixture are each cooled down to room temperature, filled into a centrifuge vessel (V=750 ml), filled up to 600 ml with acetone and centrifuged over 20 min at 4350 rpm. The clear supernatant solution is discarded and the centrifuge vessels are newly filled with the remaining reaction mixture, subsequently filled up to 600 ml with acetone and centrifuged. The solid obtained thereby is washed twice with acetone and dried under a rotary slide valve oil pump vacuum overnight. The resulting TiO₂ particles can be dispersed in amounts of more than 70 wt % in water without including any additives.

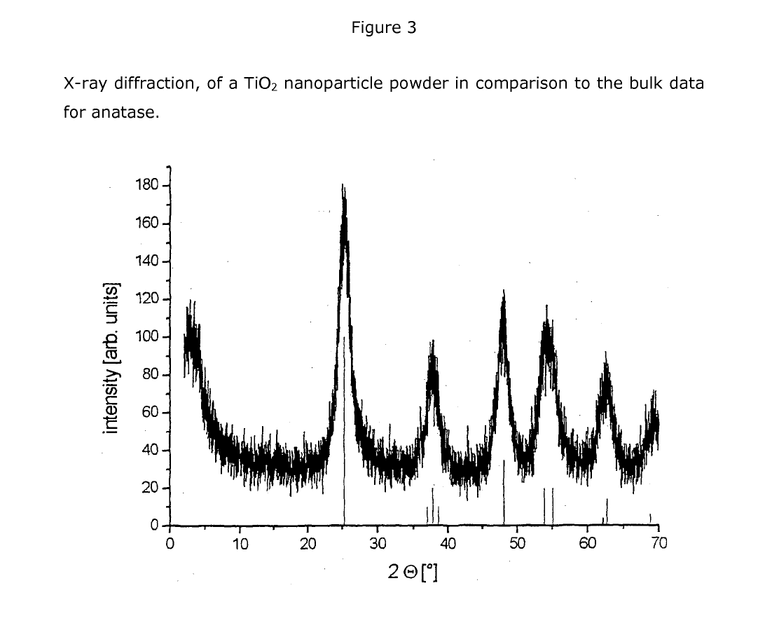

The primary particle size is about 5 nm (XRD, Debye-Scherrer, please refer to FIG. 3). XRD as well as TEM data (FIG. 2) also indicate that the particles essentially do not agglomerate in their aqueous dispersion. From the analytical ultracentrifugation results, it was concluded that the average particle size was 4.6 nm with-a standard deviation of about 25%. As crystalline phase anatase is observed in XRD analysis.

The above analytical examinations were conducted under the following conditions:
Analytical ultracentrifugation: 10 mg TiO₂ particles were dispersed in 1.990 ml water. As cuvette served a double sector measuring cell made of titanium and having a maximum surface roughness of 1 μm and a sapphire disk. The centrifuge used was Beckman Coulter AUZ, Model Optima XL-A/XL-I. The experiments were conducted with a rotational speed of 30 krpm and at a temperature of 25° C., and the detection was conducted by means of a Rayleigh interference optical system and a 675 nm laser.
Transmission electron micrographs (TEM): 10 μl sample solution were applied onto a 400 mesh grid having a diameter of 3 mm and being coated with an about 5 nm thick carbon film and left standing for about 1 to 5 minutes depending on the solvent used. The supernatant sample solution is drawn off with filter paper followed by drying the grids in an exsiccator. The TEM pictures were taken with a Philips CM 300 UT device. As emitter served LaB5 under an accelerating voltage of 200 kV and the pictures were taken with a cooled CCD camera having a resolution of 1024×1024 pixels per inch.
X-ray diffraction pattern (XRD): A Philips X'Pert powder diffractometer having a Goniometer Theta/2 Theta PW 3020, a finely focusing X-ray tube with Cu having a wavelength Kα¹=1,54056 Å, an automatic divergence slit, a sample platform, a secondary graphite monochromator and a proportional counting tube served for taking diffractograms. of the produced nanoparticle powder. Prior to measurement, the samples were pulverized in an agate mortar and the sample preparation was conducted with specific silicon single crystal carriers, optionally under fixing the powders with acetone. The measurements were conducted with an X-ray voltage of 40 kV and 30 mA in the area of °2 theta from 2 to 700 using a step width of 0.02° and counting time of one second per step. From the observed reflex broadening the primary particle size can be calculated according to Debye-Scherrer with the powder diffractogram. For this purpose the equation: L=(k·λ)/(β·cos θ) is used wherein L is the primary crystallite size, k the form factor (assumed to be 1), λ the exciting wavelength (here CuKα¹=1,54056 Å) and β the half intensity width of the corresponding reflex.

### INDUSTRIAL APPLICABILITY

The present invention is of great commercial value since the present inventors succeeded in developing a simple method for producing titanium-containing oxide particles, specifically TiO₂ which can be dispersed in water in very high concentrations without the aid of dispersing agents (surfactants). The primary particle size of the claimed particles and their tendency to form no agglomerates greatly enhance the transparency of the resulting dispersions. Moreover, the simplicity of the claimed method makes it particularly suitable for an industrial upscale.

1. A process for the production of titanium-containing oxide particles having an average primary particle size of 25 nm or less, which comprises the reaction of a hydrolysable halide-containing titanium compound with water in a reaction mixture comprising a polyol, where the volume ratio of water to polyol is in a range from about 0.01:99.9 to 40:60.

2. The process according to claim 1 wherein the titanium-containing oxide particles are titanium dioxide particles.

3. The process according to claim 1 or 2 wherein the average primary particle size is less than 10 nm.

4. The process according to claim 1 wherein the standard deviation from the average particle size is less than 40%.

5. The process according to claim 1, wherein the hydrolysable organic titanium compound is titanium tetrachloride.

6. The process according to claim 1 wherein the polyol is diethylene glycol.

7. The process according to claim 1, wherein the molar ratio water/Ti is from about 40 to 2.

8. The process according to claim 1 wherein the resulting titanium-containing oxide nanoparticles having a polyol bound to their surface are subjected to additional surface modification steps involving the replacement of the polyol by organic compounds having a polar group attaching to the surface of the particle and at least one hydrophobic group.

9. Titanium-containing oxide particles having an average primary particle size of 25 nm or less and being surface-modified with at least one polyol.

10. (canceled)

11. The process according to claim 1 wherein the resulting titanium-containing oxide nanoparticles having a polyol bound to their surface are subjected to additional surface modification steps involving the reaction of the polyol hydroxy group(s) being not attached to the surface of the particle with an organic compound having a group capable of reacting with said hydroxy group(s).

12. Titanium-containing oxide particles being obtainable according to a process as defined in claims 1, 8 or 11.
